(19) United States
(12) Patent Application Publication
(10) Pub. No.: US 2016/0364911 A1
(43) Pub. Date: Dec. 15, 2016

(54) METHOD AND APPARATUS FOR PROVIDING VIRTUAL REALITY-BASED DIGITAL OPTICAL CONTENT FOR DIGITAL OPTICAL DEVICES

(71) Applicant: ELECTRONICS AND TELECOMMUNICATIONS RESEARCH INSTITUTE, Daejeon (KR)

(72) Inventors: Dong-Sik JO, Daejeon (KR); Dae-Hwan KIM, Sejong (KR); Yong-Wan KIM, Daejeon (KR); Ki-Hong KIM, Sejong (KR); Gil-Haeng LEE, Seoul (KR)

(21) Appl. No.: 15/003,407

(22) Filed: Jan. 21, 2016

(30) Foreign Application Priority Data
Jun. 15, 2015 (KR) 10-2015-0084218

(51) Int. Cl. G06T 19/00; G02B 27/01; G06T 19/20; G06F 3/00; G06T 13/20

(52) U.S. Cl. CPC G06T 19/006; G06F 3/005; G06T 13/20; G06T 19/20; G02B 27/0172; G02B 2027/0147

(57) ABSTRACT

An apparatus and method for providing virtual reality-based digital optical content for digital optical devices. The apparatus for providing virtual reality-based digital optical content for digital optical devices includes a content management unit for providing at least one piece of digital optical content corresponding to a digital optical device, a content execution unit for executing an optical image corresponding to the at least one piece of digital optical content on a display screen, an adjustment data acquisition unit for acquiring optical image adjustment data that is input by a user of the digital optical device to adjust the optical image, and a virtual camera configuration provision unit for providing virtual camera configuration data corresponding to the at least one piece of digital optical content so as to adjust the optical image in correspondence with the optical image adjustment data.

### CROSS REFERENCE TO RELATED APPLICATION

This application claims the benefit of Korean Patent Application No. 10-2015-0084218, filed Jun. 15, 2015, which is hereby incorporated by reference in its entirety into this application.

### BACKGROUND OF THE INVENTION

1. Technical Field

The present invention generally relates to technology for providing virtual reality technology-based digital optical content to digital optical devices and, more particularly, to technology for providing digital optical content to digital optical devices, such as a telescope or a microscope, using the immersive virtualization interaction of virtual reality.

2. Description of the Related Art

Among recent virtual reality technologies, technology for a Head Mounted Display (HMD) worn by a user has been popularized. Accordingly, the number of normal users who experience, in real time, various situations that occur in real environments or situations that are difficult to actually experience, based on such technology, has increased. Further, such a display technology has been extended and applied to entertainment fields via visualization, interaction, and simulation, which are principal elements of virtual reality.

In accordance with this trend, technology is required that applies techniques corresponding to the principal elements of virtual reality even to analog optical devices, such as a telescope and a microscope, which are used for scientific or educational purposes, and then provides digital experiences to users.

Therefore, there is a need for virtual reality-based digital optical content technology that associates digital optical devices with digital content which enables real-time experiences, thus providing highly immersive experiences.

### PRIOR ART DOCUMENTS

### Patent Documents

(Patent Document 1) Korean Patent Application Publication No 10-2013-0121520 (Date of publication: Nov. 6, 2013)(entitled “Stereo microscope system”)

### SUMMARY OF THE INVENTION

Accordingly, the present invention has been made keeping in mind the above problems occurring in the prior art, and an object of the present invention is to provide a digital experience environment to users by providing digital optical content to a digital optical device.

Another object of the present invention is to provide various experiences by freely processing digital optical content, thus maximizing educational effects in medical or scientific educational fields.

A further object of the present invention is to apply the fundamental technology of the present invention, which uses digital optical content, to technology for magnifying and viewing faraway objects or very small objects, as in the case of a periscope, a magnifier, or a telescope, thus utilizing the applied technology.

In accordance with an aspect of the present invention to accomplish the above objects, there is provided an apparatus for providing virtual reality-based digital optical content for digital optical devices, including a content management unit for providing at least one piece of digital optical content corresponding to a digital optical device; a content execution unit for executing an optical image corresponding to the at least one piece of digital optical content on a display screen; an adjustment data acquisition unit for acquiring optical image adjustment data that is input by a user of the digital optical device to adjust the optical image; and a virtual camera configuration provision unit for providing virtual camera configuration data corresponding to the at least one piece of digital optical content so as to adjust the optical image in correspondence with the optical image adjustment data.

The content management unit may provide animation motion data associable with an operation model corresponding to the optical image, together with the at least one piece of digital optical content.

The content management unit may provide a virtual light source, together with the at least one piece of digital optical content so as to provide lighting conditions corresponding to an analog optical device.

The adjustment data acquisition unit may acquire the optical image adjustment data using a gyro sensor attached to at least one adjustment interface corresponding to the digital optical device.

The virtual camera configuration data may be applied to a virtual camera model corresponding to the at least one piece of digital optical content and be used to adjust at least one of a magnification power and a viewing angle corresponding to the optical image.

The virtual camera configuration data may be used to adjust a magnification power corresponding to the optical image in a digital manner, based on the optical image adjustment data corresponding to a high-magnification lens of the at least one adjustment interface.

The content execution unit may execute the at least one piece of digital optical content using at least one of a mobile computer and the user's smart device that are included in the digital optical device.

The content management unit may update the at least one piece of digital optical content using at least one of the mobile computer and the smart device.

The content execution unit may acquire data of optical simulation performed on at least one of a Personal Computer (PC) and a supercomputer, match the optical simulation data for use in augmented reality, and execute matched results on the display screen.

The at least one piece of digital optical content may include resultant data obtained by performing numerical simulation using at least one of the PC and the supercomputer.

The at least one piece of digital optical content may correspond to optical field data for at least one of physics, chemistry, biology, and earth science.

The at least one piece of digital optical content may be used to execute the optical image corresponding to at least one of a two-dimensional (2D) image and a three-dimensional (3D) image.

In accordance with another aspect of the present invention to accomplish the above objects, there is provided a method for providing virtual reality-based digital optical content for digital optical devices, including providing at least one piece of digital optical content corresponding to a digital optical device; executing an optical image corresponding to the at least one piece of digital optical content on a display screen; acquiring optical image adjustment data that is input by a user of the digital optical device to adjust the optical image; and providing virtual camera configuration data corresponding to the at least one piece of digital optical content so as to adjust the optical image in correspondence with the optical image adjustment data.

Providing the at least one piece of digital optical content may be configured to provide animation motion data associable with an operation model corresponding to the optical image, together with the at least one piece of digital optical content.

Providing the at least one piece of digital optical content may be configured to provide a virtual light source, together with the at least one piece of digital optical content, so as to provide lighting conditions corresponding to an analog optical device.

Acquiring the optical image adjustment data may be configured to acquire the optical image adjustment data using a gyro sensor attached to at least one adjustment interface corresponding to the digital optical device.

The virtual camera configuration data may be applied to a virtual camera model corresponding to the at least one piece of digital optical content and may be used to adjust at least one of a magnification power and a viewing angle corresponding to the optical image.

Executing the optical image may be configured to execute the at least one piece of digital optical content using a mobile computer included in the digital optical device.

The at least one piece of digital optical content may correspond to optical field data for at least one of physics, chemistry, biology, and earth science.

The at least one piece of digital optical content may be used to execute the optical image corresponding to at least one of a two-dimensional (2D) image and a three-dimensional (3D) image.

In accordance with a further aspect of the present invention to accomplish the above objects, there is provided a digital optical device using virtual reality-based digital optical content, including a digital optical content provision apparatus for providing at least one piece of digital optical content; a mobile computer for executing an optical image corresponding to the at least one piece of digital optical content; a display screen for displaying the optical image; a lens for allowing a user to put his or her eye to the lens to view the displayed optical image; and at least one adjustment interface for allowing the user to adjust the optical image.

The digital optical content provision apparatus may provide animation motion data associable with an operation model corresponding to the optical image, together with the at least one piece of digital optical content.

The at least one adjustment interface may include at least one gyro sensor so as to generate optical image adjustment data corresponding to adjustment by the user.

The digital optical device may have a shape corresponding to that of an analog optical device in an optical field corresponding to the at least one piece of digital optical content.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing an apparatus for providing virtual reality-based digital optical content for digital optical devices according to an embodiment of the present invention;

FIG. 2 is a block diagram showing a digital optical device using virtual reality-based digital optical content according to an embodiment of the present invention;

FIG. 3 is a diagram showing digital optical content according to an embodiment of the present invention;

FIG. 4 is a diagram showing a digital telescope using a method for providing digital optical content according to an embodiment of the present invention,

FIG. 5 is a diagram showing a digital microscope using the method for providing digital optical content according to an embodiment of the present invention;

FIG. 6 is an operation flowchart showing a method for providing virtual reality-based digital optical content for digital optical devices according to an embodiment of the present invention; and

FIG. 7 is an operation flowchart showing in detail a method for providing virtual reality-based digital optical content for digital optical devices according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, preferred embodiments of the present invention will be described in detail with reference to the attached drawings.

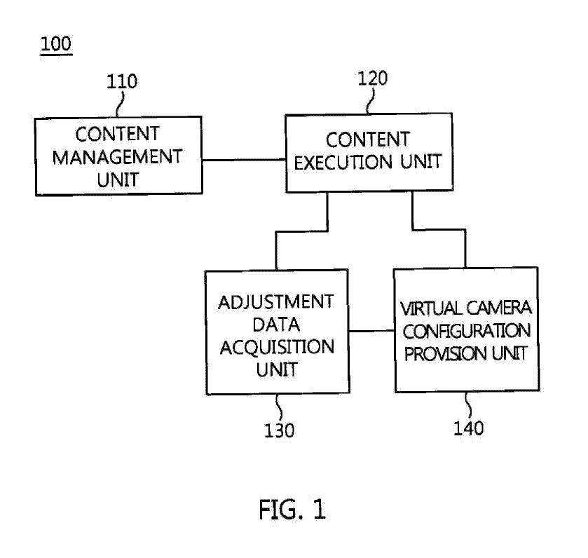

FIG. 1 is a block diagram showing an apparatus for providing virtual reality-based digital optical content for digital optical devices according to an embodiment of the present invention.

Referring to FIG. 1, an apparatus 100 for providing virtual reality-based digital optical content for digital optical devices according to an embodiment of the present invention includes a content management unit 110, a content execution unit 120, an adjustment data acquisition unit 130, and a virtual camera configuration provision unit 140.

The content management unit 110 may provide at least one piece of digital optical content corresponding to a digital optical device.

Here, animation motion data associable with an operation model corresponding to an optical image may be provided together with at least one piece of digital optical content. An optical image may be, for example, a two-dimensional (2D) or three-dimensional (3D) digital model which includes biological data, such as a digital cell, or astronomical data related to planets such as Saturn. In this case, motion effects may be assigned to the digital model in association with an operation model corresponding to the digital model by providing animation motion data.

Here, to provide lighting conditions corresponding to an analog optical device, a virtual light source together with at least one piece of digital optical content may be provided. That is, to present the same environment as the situation in which an actual analog optical device is used, a lighting device is virtually provided, thus providing a more realistic experience to the user.

At this time, at least one piece of digital optical content may correspond to optical field data about at least one of physics, chemistry, biology, and earth science. For example, the digital optical content may correspond to chemical data about a chemical material, biological data about, for example, a digital cell, and earth science data about, for example, space or planets.

The at least one piece of digital optical content may be used to execute an optical image corresponding to at least one of a 2D image and a 3D image.

Here, at least one piece of digital optical content may be updated using at least one of a mobile computer and the user's smart device which are included in the digital optical device. For example, information about the latest updates may be acquired over a network connected to the mobile computer or the smart device, and at least one piece of digital optical content may be updated based on the acquired information.

The content execution unit 120 may execute an optical image corresponding to the at least one piece of digital optical content on a display screen.

Here, the at least one piece of digital optical content may be executed using at least one of the mobile computer and the user's smart device which are included in the digital optical device. For example, the digital optical content may be executed via a mobile Operating System (OS) corresponding to the mobile computer, and an optical image corresponding to the results of execution of the digital optical content may be displayed on the display screen, thus enabling the digital optical content to be visualized such that the user may view it through an optical lens. Further, the digital optical content may be executed using an OS installed on the user's smart device, and the results of execution thereof may be visualized such that the user may view the results on the screen of the smart device.

Here, data of optical simulation performed on at least one of a PC and a supercomputer may be acquired and be matched for use in augmented reality, and thus the matched results may be executed on the display screen. For example, the mobile computer or the user's smart device included in the digital optical device may have limitations related to the amount of data that is desired to be provided or to device performance. Therefore, optical simulation may be performed via a high-performance PC or a supercomputer, and only the resultant data of the simulation may be acquired and visualized.

In this case, at least one piece of digital optical content may include resultant data obtained by performing numerical simulation using at least one of the PC and the supercomputer. For example, after specific digital optical content has been executed on the supercomputer, simulation may be performed while adjustable numerical values, including the magnification power and the viewing angle, are changed. Thereafter, the resultant data of the completed simulation may be visualized and viewed.

The adjustment data acquisition unit 130 may acquire optical image adjustment data that is input by the user of the digital optical device to adjust the optical image. That is, the user may perform the same adjustment as that of an analog optical device, and may acquire optical image adjustment data to incorporate the results of adjustment into the optical image. Therefore, the user may gain the same experience as when using the analog optical device. For example, a virtual reality digital microscope may be configured such that the approximate distance between the lens and the sample is adjusted using a coarse focus knob, and the focus is precisely adjusted using a fine focus knob. Further, a rotation azimuth angle sensor, capable of recognizing rotation, is attached to an object lens, so that the object lens, which changes according to the rotating scheme, is recognized, and thus a magnification function, that is, a zoom function, may be adjusted.

Here, optical image adjustment data may be acquired using a gyro sensor attached to at least one adjustment interface corresponding to the digital optical device.

For example, if it is assumed that the user adjusts the adjustment interface corresponding to a zoom function to magnify an optical image, the rotation angle of the zoom function adjustment interface may be calculated using a gyro sensor attached to the zoom function adjustment interface. Here, the level at which the zoom function is applied depending on the rotation angle may be set in advance, and optical image adjustment data may be acquired as the value corresponding to the level.

The virtual camera configuration provision unit 140 may provide virtual camera configuration data corresponding to the at least one piece of digital optical content so as to adjust the optical image in correspondence with the optical image adjustment data

The virtual camera configuration data may be applied to a virtual camera model corresponding to at least one piece of digital optical content, and may be configured to adjust at least one of the magnification power and the viewing angle corresponding to the optical image.

The virtual camera configuration data may be used to adjust the magnification power corresponding to the optical image in a digital manner, based on the optical image adjustment data corresponding to the high-magnification lens of the at least one adjustment interface. For example, for the virtual reality digital microscope, optical image adjustment data corresponding to the magnification power of the object lens may be acquired as the user adjusts the magnification power of the object lens. Here, virtual camera configuration data is provided in correspondence with the optical image adjustment data depending on the magnification power of the object lens, thus allowing the user to experience virtual reality interaction.

Here, the magnification power of the image such as in the high-magnification lens may be controlled in a digital manner. Alternatively, when an interface implemented in an analog manner is manipulated, such manipulation may be sensed via the sensor, and data corresponding to the manipulation may be generated and used to control the magnification power.

Further, digital optical content according to the present invention may be configured to be continuously updated.

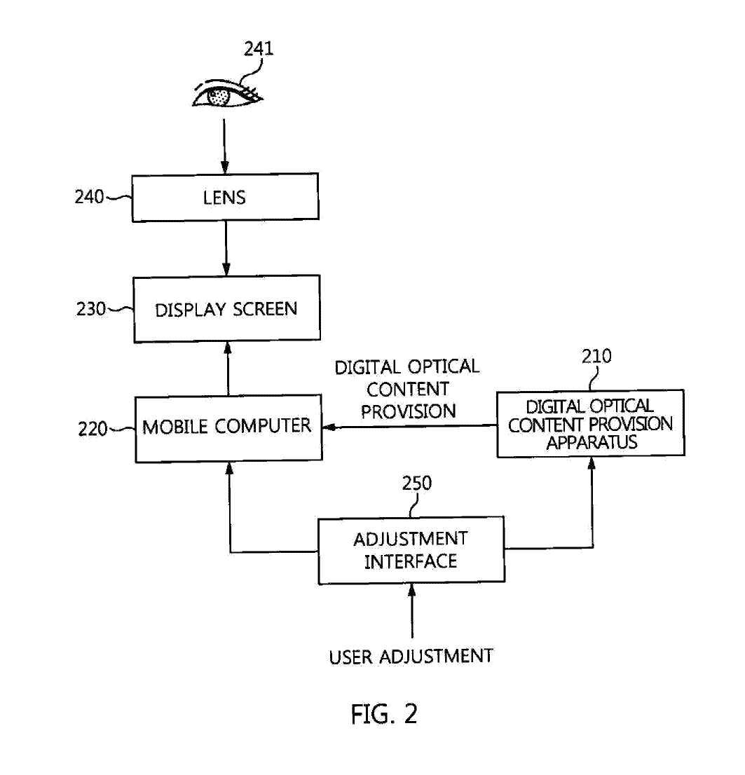

FIG. 2 is a block diagram showing a digital optical device using virtual reality-based digital optical content according to an embodiment of the present invention.

Referring to FIG. 2, a digital optical device using virtual reality-based digital optical content according to an embodiment of the present invention may include a digital optical content provision apparatus 210, a mobile computer 220, a display screen 230, a lens 240, and an adjustment interface 250.

The digital optical content provision apparatus 210 may provide at least one piece of digital optical content.

In this case, animation motion data, which is associable with an operation model corresponding to an optical image, may be provided together with the at least one piece of digital optical content.

Further, the at least one piece of digital optical content may be content corresponding to a given digital optical device. For example, when the digital optical device is an astronomical telescope, digital optical content that provides earth science data related to space or planets may be provided.

The mobile computer 220 may execute an optical image corresponding to the at least one piece of digital optical content.

The display screen 230 may display the optical image.

The lens 240 allows the user to put his or her eye 241 to the lens 240 so as to view the displayed optical image.

That is, when at least one piece of digital optical content is executed via the mobile OS of the mobile computer 220, and an optical image corresponding to the results of execution is displayed on the display screen 230, the user may view the visualized digital optical content through the lens 240.

The adjustment interface 250 allows the user to adjust the optical image.

Here, the adjustment interface 250 may include at least one gyro sensor for generating optical image adjustment data corresponding to the adjustment by the user.

Further, the digital optical device according to the present invention may have a shape corresponding to that of the analog optical device in an optical field corresponding to the at least one piece of digital optical content. For example, when the digital optical content corresponds to biological data indicating a microbe or a cellular tissue, the digital optical device may have a shape corresponding to that of an optical microscope.

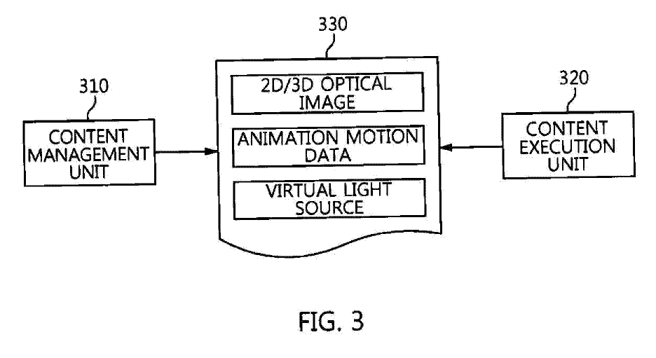

FIG. 3 is a diagram showing digital optical content according to an embodiment of the present invention.

Referring to FIG. 3, as digital optical content 330 according to an embodiment of the present invention, at least one of an optical image corresponding to at least one of a 2D image and a 3D image, animation motion data, and a virtual light source may be provided when the digital optical content 330 is provided from a content management unit 310 to a content execution unit 320.

Here, the optical image may correspond to a 2D or 3D digital model for biological data such as a digital cell, or for astronomical data related to planets such as Saturn.

Further, the animation motion data may be data enabling the 2D or 3D digital model corresponding to the optical image to be associated with an operation model, and may be utilized as basic data used to provide the digital optical content 330, together with the optical image.

Furthermore, the virtual light source is configured such that lighting conditions are provided via the digital optical content 330, thus providing the same environment as the situation in which the actual analog optical device, such as that used for biology, earth science, chemistry, or physics, is used.

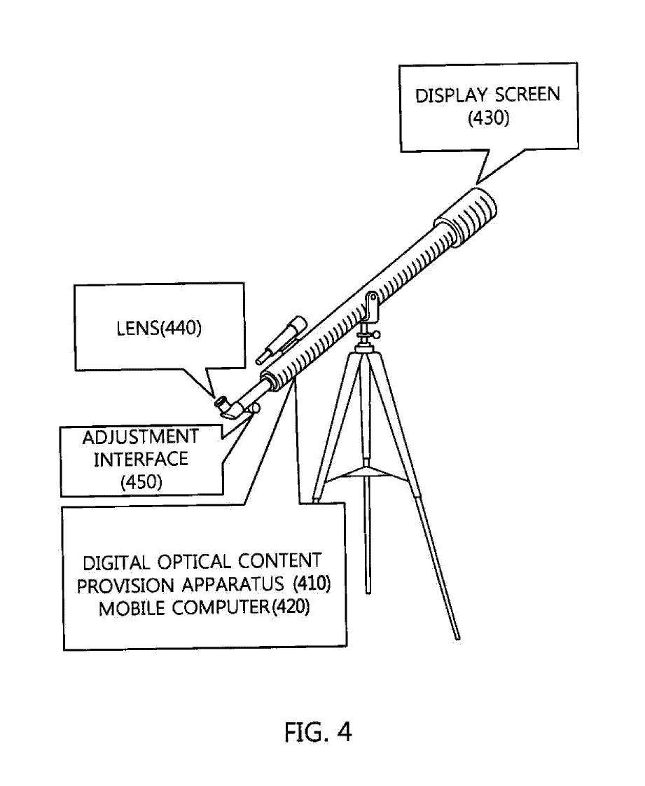

FIG. 4 is a diagram showing a digital telescope using a method for providing digital optical content according to an embodiment of the present invention.

Referring to FIG. 4, a digital telescope or a digital astronomical telescope, to which the digital optical content provision method according to the embodiment of the present invention is applied, is illustrated.

Here, the digital telescope is implemented to use the outward appearance or the interface of an analog telescope without change, but a display screen 430 or a lens 440 is modified to provide digital optical content, thus visualizing and showing an optical image corresponding to the digital optical content to the user.

Further, the digital telescope may be equipped with a mobile computer 420 capable of running operating software such as a mobile OS, and an interface may be configured such that the user can control interactive input/output for the digital optical content.

For example, when a zoom function for magnifying an optical image is intended to be performed, a gyro sensor is attached to an adjustment interface 450 to recognize the rotation angle, and the zoom function is set depending on the rotation angle, thus acquiring data used to adjust the optical image. Therefore, by means of the acquired data, immediate feedback may be reflected on digital optical content.

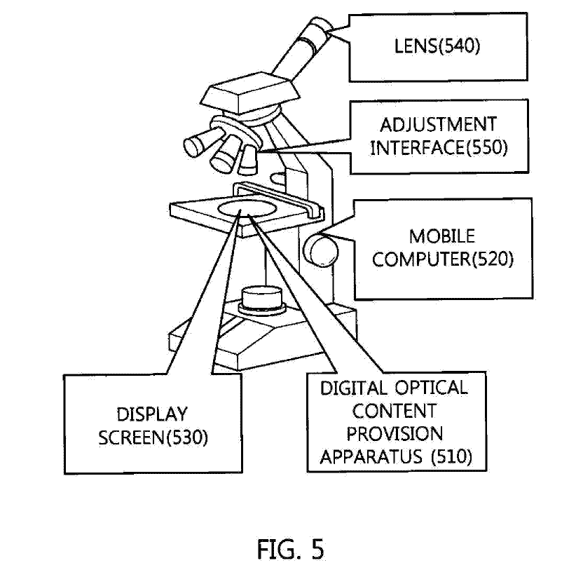

FIG. 5 is a diagram showing a digital microscope using the digital optical content provision method according to an embodiment of the present invention.

Referring to FIG. 5, the digital microscope using the digital optical content provision method according to the embodiment of the present invention has object lenses corresponding to various magnification powers in the same way as an analog telescope, and such lenses may be adjusted via an adjustment interface 550.

The digital microscope of FIG. 5 has the same fundamental configuration as the digital telescope of FIG. 4 with the exception of the adjustment interface 550, wherein the fundamental configuration includes a digital optical content provision apparatus 510, a mobile computer 520, a display screen 530, and a lens 540. Further, respective flows of operation of the components are the same as those of FIG. 4, and thus a detailed description thereof will be omitted.

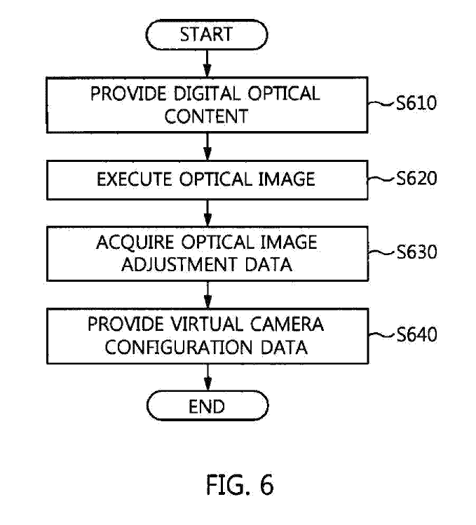

FIG. 6 is an operation flowchart showing a method for providing virtual reality-based digital optical content for digital optical devices according to an embodiment of the present invention.

Referring to FIG. 6, the method for providing virtual reality-based digital optical content for digital optical devices according to the embodiment of the present invention may provide at least one piece of digital optical content corresponding to a digital optical device at step S610.

Here, animation motion data associable with an operation model corresponding to an optical image may be provided together with at least one piece of digital optical content. An optical image may be, for example, a two-dimensional (2D) or three-dimensional (3D) digital model which includes biological data, such as a digital cell, or astronomical data related to planets such as Saturn. In this case, motion effects may be assigned to the digital model in association with an operation model corresponding to the digital model by providing animation motion data.

Here, to provide lighting conditions corresponding to an analog optical device, a virtual light source together with at least one piece of digital optical content may be provided. That is, to present the same environment as the situation in which an actual analog optical device is used, a lighting device is virtually provided, thus providing a more realistic experience to the user.

At this time, at least one piece of digital optical content may correspond to optical field data about at least one of physics, chemistry, biology, and earth science. For example, the digital optical content may correspond to chemical data about a chemical material, biological data about, for example, a digital cell, and earth science data about, for example, space or planets.

The at least one piece of digital optical content may be used to execute an optical image corresponding to at least one of a 2D image and a 3D image.

Here, at least one piece of digital optical content may be updated using at least one of a mobile computer and the user's smart device which are included in the digital optical device. For example, information about the latest updates may be acquired over a network connected to the mobile computer or the smart device, and at least one piece of digital optical content may be updated based on the acquired information.

Next, the method for providing virtual reality-based digital optical content for digital optical devices according to the embodiment of the present invention may execute an optical image corresponding to the at least one piece of digital optical content on a display screen at step S620.

Here, the at least one piece of digital optical content may be executed using at least one of the mobile computer and the user's smart device which are included in the digital optical device. For example, the digital optical content may be executed via a mobile Operating System (OS) corresponding to the mobile computer, and an optical image corresponding to the results of execution of the digital optical content may be displayed on the display screen, thus enabling the digital optical content to be visualized such that the user may view it through an optical lens. Further, the digital optical content may be executed using an OS installed on the user's smart device, and the results of execution thereof may be visualized such that the user may view the results on the screen of the smart device.

Data of optical simulation performed on at least one of a PC and a supercomputer may be acquired and be matched for use in augmented reality, and thus the matched results may be executed on the display screen. For example, the mobile computer or the user's smart device included in the digital optical device may have limitations related to the amount of data that is desired to be provided or to device performance. Therefore, optical simulation may be performed via a high-performance PC or a supercomputer, and only the resultant data of the simulation may be acquired and visualized.

In this case, at least one piece of digital optical content may include resultant data obtained by performing numerical simulation using at least one of the PC and the supercomputer. For example, after specific digital optical content has been executed on the supercomputer, simulation may be performed while adjustable numerical values, including the magnification power and the viewing angle, are changed. Thereafter, the resultant data of the completed simulation may be visualized and viewed.

Further, the method for providing virtual reality-based digital optical content for digital optical devices according to the embodiment of the present invention may acquire optical image adjustment data that is input by the user of the digital optical device to adjust the optical image at step S630. That is, the user may perform the same adjustment as that of an analog optical device, and may acquire optical image adjustment data to incorporate the results of adjustment into the optical image. Therefore, the user may gain the same experience as when using the analog optical device. For example, a virtual reality digital microscope may be configured such that the approximate distance between the lens and the sample is adjusted using a coarse focus knob, and the focus is precisely adjusted using a fine focus knob. Further, a rotation azimuth angle sensor, capable of recognizing rotation, is attached to an object lens, so that the object lens, which changes according to the rotating scheme, is recognized, and thus a magnification function, that is, a zoom function, may be adjusted.

Here, optical image adjustment data may be acquired using a gyro sensor attached to at least one adjustment interface corresponding to the digital optical device.

For example, if it is assumed that the user adjusts the adjustment interface corresponding to a zoom function to magnify an optical image, the rotation angle of the zoom function adjustment interface may be calculated using a gyro sensor attached to the zoom function adjustment interface. Here, the level at which the zoom function is applied depending on the rotation angle may be set in advance, and optical image adjustment data may be acquired as the value corresponding to the level.

Further, the method for providing virtual reality-based digital optical content for digital optical devices according to the embodiment of the present invention may provide virtual camera configuration data corresponding to at least one piece of digital optical content so as to adjust the optical image in correspondence with the optical image adjustment data at step S640.

The virtual camera configuration data may be applied to a virtual camera model corresponding to at least one piece of digital optical content, and may be configured to adjust at least one of the magnification power and the viewing angle corresponding to the optical image.

The virtual camera configuration data may be used to adjust the magnification power corresponding to the optical image in a digital manner, based on the optical image adjustment data corresponding to the high-magnification lens of the at least one adjustment interface. For example, for the virtual reality digital microscope, optical image adjustment data corresponding to the magnification power of the object lens may be acquired as the user adjusts the magnification power of the object lens. Here, virtual camera configuration data is provided in correspondence with the optical image adjustment data depending on the magnification power of the object lens, thus allowing the user to experience virtual reality interaction.

In this case, the magnification power of the image such as in the high-magnification lens may be controlled in a digital manner. Alternatively, when an interface implemented in an analog manner is manipulated, such manipulation may be sensed via the sensor, and data corresponding to the manipulation may be generated and used to control the magnification power.

Further, digital optical content according to the present invention may be configured to be continuously updated.

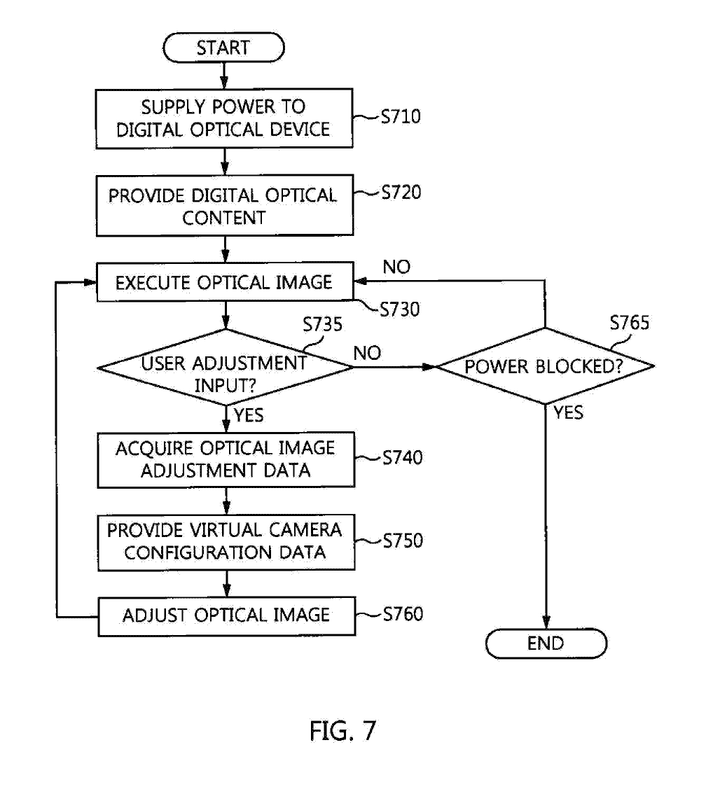

FIG. 7 is an operation flowchart showing in detail the method for providing virtual reality-based digital optical content for digital optical devices according to an embodiment of the present invention.

Referring to FIG. 7, in the method for providing virtual reality-based digital optical content for digital optical devices according to the embodiment of the present invention, a digital optical device may be supplied with power for operation at step S710.

Thereafter, the content management unit of the digital optical content provision apparatus included in the digital optical device may provide digital optical content to execute the content at step S720.

Here, data of optical simulation performed on at least one of a PC and a supercomputer may be acquired and be matched for use in augmented reality, and thus the matched results may be executed on the display screen. For example, the mobile computer or the user's smart device included in the digital optical device may have limitations related to the amount of data that is desired to be provided or to device performance. Therefore, optical simulation may be performed via a high-performance PC or a supercomputer, and only the resultant data of the simulation may be acquired and visualized.

In this case, at least one piece of digital optical content may include resultant data obtained by performing numerical simulation using at least one of the PC and the supercomputer. For example, after specific digital optical content has been executed on the supercomputer, simulation may be performed while adjustable numerical values, including the magnification power and the viewing angle, are changed. Thereafter, the resultant data of the completed simulation may be visualized and viewed.

Next, the digital optical content may be executed by the content execution unit via the mobile computer, and then an optical image may be executed at step S730,

Thereafter, it is determined whether an adjustment input has been made by the user via an adjustment interface while the optical image is being executed at step S735.

If it is determined at step S735 that the adjustment input has been made, optical image adjustment data corresponding to the adjustment input may be acquired.

Thereafter, the mobile computer is provided with virtual camera configuration data corresponding to the optical image adjustment data at step S750. After the optical image is adjusted at step S760, the optical image may continue to be executed at step S730.

If it is determined at step S735 that an adjustment input has not been made, whether the power of the digital optical device has been blocked is determined at step S765.

If it is determined at step S765 that the power has not been blocked, the optical image continues to be executed at step S730, whereas if it is determined that the power has been blocked, the use of the digital optical device may be terminated.

In accordance with the present invention, a digital experience environment may be provided to users by providing digital optical content to a digital optical device.

Further, the present invention may provide various experiences by freely processing digital optical content, thus maximizing educational effects in medical or scientific educational fields.

Furthermore, the present invention may apply the fundamental technology thereof, which uses digital optical content, to technology for magnifying and viewing faraway objects or very small objects, as in the case of a periscope, a magnifier, or a telescope, thus utilizing the applied technology.

As described above, in the method and apparatus for providing virtual reality-based digital optical content for digital optical devices according to the present invention, the configurations and schemes in the above-described embodiments are not limitedly applied, and some or all of the above embodiments can be selectively combined and configured so that various modifications are possible.

What is claimed is:

1. An apparatus for providing virtual reality-based digital optical content for digital optical devices, comprising:
a content management unit for providing at least one piece of digital optical content corresponding to a digital optical device;
a content execution unit for executing an optical image corresponding to the at least one piece of digital optical content on a display screen;
an adjustment data acquisition unit for acquiring optical image adjustment data that is input by a user of the digital optical device to adjust the optical image; and
a virtual camera configuration provision unit for providing virtual camera configuration data corresponding to the at least one piece of digital optical content so as to adjust the optical image in correspondence with the optical image adjustment data.

2. The apparatus of claim 1, wherein the content management unit provides animation motion data associable with an operation model corresponding to the optical image, together with the at least one piece of digital optical content.

3. The apparatus of claim 2, wherein the content management unit provides a virtual light source, together with the at least one piece of digital optical content, so as to provide lighting conditions corresponding to an analog optical device.

4. The apparatus of claim 1, wherein the adjustment data acquisition unit acquires the optical image adjustment data using a gyro sensor attached to at least one adjustment interface corresponding to the digital optical device.

5. The apparatus of claim 4, wherein the virtual camera configuration data is applied to a virtual camera model corresponding to the at least one piece of digital optical content and is used to adjust at least one of a magnification power and a viewing angle corresponding to the optical image.

6. The apparatus of claim 5, wherein the virtual camera configuration data is used to adjust a magnification power corresponding to the optical image in a digital manner, based on the optical image adjustment data corresponding to a high-magnification lens of the at least one adjustment interface.

7. The apparatus of claim 1, wherein the content execution unit executes the at least one piece of digital optical content using at least one of a mobile computer and the user's smart device that are included in the digital optical device.

8. The apparatus of claim 7, wherein the content management unit updates the at least one piece of digital optical content using at least one of the mobile computer and the smart device.

9. The apparatus of claim 1, wherein the content execution unit acquires data of optical simulation performed on at least one of a Personal Computer (PC) and a supercomputer, matches the optical simulation data for use in augmented reality, and executes matched results on the display screen.

10. The apparatus of claim 9, wherein the at least one piece of digital optical content includes resultant data obtained by performing numerical simulation using at least one of the PC and the supercomputer.

11. The apparatus of claim 1, wherein the at least one piece of digital optical content corresponds to optical field data for at least one of physics, chemistry, biology, and earth science.

12. The apparatus of claim 11, wherein the at least one piece of digital optical content is used to execute the optical image corresponding to at least one of a two-dimensional (2D) image and a three-dimensional (3D) image.

13. A method for providing virtual reality-based digital optical content for digital optical devices, comprising:
providing at least one piece of digital optical content corresponding to a digital optical device;
executing an optical image corresponding to the at least one piece of digital optical content on a display screen;
acquiring optical image adjustment data that is input by a user of the digital optical device to adjust the optical image; and
providing virtual camera configuration data corresponding to the at least one piece of digital optical content so as to adjust the optical image in correspondence with the optical image adjustment data

14. The method of claim 13, wherein providing the at least one piece of digital optical content is configured to provide animation motion data associable with an operation model corresponding to the optical image, together with the at least one piece of digital optical content.

15. The method of claim 14, wherein providing the at least one piece of digital optical content is configured to provide a virtual light source, together with the at least one piece of digital optical content, so as to provide lighting conditions corresponding to an analog optical device.

16. The method of claim 13, wherein acquiring the optical image adjustment data is configured to acquire the optical image adjustment data using a gyro sensor attached to at least one adjustment interface corresponding to the digital optical device.

17. A digital optical device using virtual reality-based digital optical content, comprising:
a digital optical content provision apparatus for providing at least one piece of digital optical content;
a mobile computer for executing an optical image corresponding to the at least one piece of digital optical content;
a display screen for displaying the optical image;
a lens for allowing a user to put his or her eye to the lens to view the displayed optical image; and
at least one adjustment interface for allowing the user to adjust the optical image.

18. The digital optical device of claim 17, wherein the digital optical content provision apparatus provides animation motion data associable with an operation model corresponding to the optical image, together with the at least one piece of digital optical content.

19. The digital optical device of claim 17, wherein the at least one adjustment interface comprises at least one of at least one gyro sensor, at least one high-magnification lens for adjusting a magnification power, and a viewing angle adjuster for adjusting a viewing angle, so as to generate optical image adjustment data corresponding to adjustment by the user.

20. The digital optical device of claim 17, wherein the digital optical device has a shape corresponding to that of an analog optical device in an optical field corresponding to the at least one piece of digital optical content.
